(19) United States
(12) Patent Application Publication
(10) Pub. No.: US 2026/0115084 A1
(43) Pub. Date: Apr. 30, 2026

(54) THERAPY ASSISTIVE SYSTEM

(71) Applicant: IMAM ABDULRAHMAN BIN FAISAL UNIVERSITY, Dammam (SA)

(72) Inventors: Nibras Naji BUHULAYQAH, Qatif (SA); Hala EL-WAKEEL, Dammam (SA); Amal ALKHAYYAL, Dammam (SA); Shahad Mohammed AL HANI, Safwa (SA); Hawra'a AL SWIKET, Qatif (SA)

(73) Assignee: IMAM ABDULRAHMAN BIN FAISAL UNIVERSITY, Dammam (SA)

(21) Appl. No.: 18/933,662

(22) Filed: Oct. 31, 2024

(51) Int. Cl. A61H 3/00; A43B 3/34; A43D 1/02

(52) U.S. Cl. CPC A61H 3/00; A43B 3/34; A43D 1/025; A61H 2230/00

(57) ABSTRACT

A therapy assistive system includes a multi-layered rounded mat including a lower section and an upper section. The therapy assistive system further includes a movable character and a set of flat hexagonal response tags. A first layer of the multi-layered rounded mat is a bottommost layer. A second layer of the multi-layered rounded mat is a middle layer including an interactive surface, the interactive surface being configured to detect a location of the movable character and response tags present on the interactive surface. The middle layer further includes circuitry having a wireless communication sensor and a light sensor.

### BACKGROUND

### Technical Field

The present disclosure is directed towards systems for remediation of psychological challenges, and more particularly, directed towards a therapy assistive system.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Mental health disorder diagnoses have been steadily increasing, with a 34.6% increase in the prevalence of mental illness over the last decade. Specifically, obsessive compulsive disorder (OCD) ranks as the fourth most prevalent mental disorder in the world. OCD is a long-lasting disorder in which a person may experience uncontrollable and recurring thoughts (obsessions) and engage in repetitive behaviors (compulsions). People with OCD have time-consuming symptoms, such as, but not limited to, fear of contamination, fear of uncertainty, aggressive thoughts about losing control, and hand-washing until skin damage, that may cause significant distress or interfere with daily life. As a result, OCD may result in substantial disability and interference with a person's daily life. The World Health Organization (WHO) recognizes OCD as one of the top ten most incapacitating conditions in terms of its impact on daily functioning. This emphasizes the profound and far-reaching effects of OCD on the well-being of diagnosed individuals and underscores the importance of addressing and treating OCD effectively. Additionally, OCD in children may be an obstacle to the normal development of the children. OCD affects the personality, behavior, and lifestyle of the child and the family. OCD occurs in children mostly as a result of genetics. In some cases, when the symptoms of OCD are able to be treated immediately, they disappear before affecting the child further. In other cases, when the OCD symptoms are not treated immediately, they may increase in severity and begin to affect the child's brain.

Presently, there are limited treatment options for OCD and associated illnesses. OCD may also be managed by targeted drug intervention such as selective serotonin reuptake inhibitors (SSRIs). Serotonin reuptake inhibitors block the path of reabsorption of serotonin hormone back into the body. This helps in maintaining a higher level of serotonin hormone in bloodstream and the brain, helping with obsessions and compulsions associated with OCD. However, in more than one parameters, the above described therapies and medicinal interventions are inadequate and inefficient in managing the OCD. Sometimes, a patient with OCD benefits by drug therapy and/or undergoing practice recovery therapy under a treating medical professional and cognitive behavioral therapy (CBT). CBT is a type of psychotherapy that helps patients manage mental health and physical conditions by changing how they think and behave. CBT may enable the patient to not divulge into usual compulsive rituals. CBT, however, may only be successful in 50% to 60% of patients. CBT additionally may include exposure and response prevention (ERP), which involves exposing the patient to a feared object or obsession over time. However, CBT in conjunction with ERP may or may not result in improvement in the patient. Hence, a need arises for a better, efficient, and synergistic approach to manage OCD in children and adults.

Another approach of OCD treatment is cognitive bias modification for interpretation (CBM-I), which leverages the internet and technology to bridge gaps in traditional CBT methods. CBM-I involves training patients to interpret ambiguous social stimuli in a more positive and/or less negative fashion CBM-I trains patients by attempting to change disorder-specific maladaptive cognitive biases through repeated training on specific cognitive tasks. Prior research suggests that treatment sessions may not necessarily demand in-person visits with the treating medical professional and that, in certain instances, this form of treatment may be superior to traditional therapies such as drug therapy and CBT.

Accordingly, it is one object of the present disclosure to provide a therapy assistive system, which may provide a superior solution to OCD treatment as compared to more traditional methods.

### SUMMARY

In one embodiment, a therapy assistive system is described. In one embodiment, the therapy assistive system comprises a multi-layered rounded mat comprising a lower section and an upper section. The lower section is being foldable over a portion of an upper surface of the upper section at a straight constriction of the thickness of the mat. The upper section has a storage compartment disposed on the upper surface opposite the lower section. The therapy assistive system further comprises a movable character and a set of flat hexagonal response tags, each having a unique pattern of cut-outs penetrating through a body of the flat hexagonal response tag. A first layer of the multi-layered rounded mat is a bottommost layer comprising at least one selected from the group consisting of a silicone, a polyurethane, a rubber, and a plastic. A second layer of the multi-layered rounded mat is a middle layer comprising an interactive surface, the interactive surface being configured to detect a location of the movable character and the flat hexagonal response tags present on the interactive surface. The second layer further comprises a circuitry having a wireless communication sensor and a light sensor, the light sensor being in communication with the wireless communication sensor and configured to identify the unique pattern of cut-outs present on the flat hexagonal response tags and relay an identity of the flat hexagonal response tags based on the unique pattern of cut-outs to the wireless communication sensor. The wireless communication sensor is configured to wirelessly connect the second layer of the multi-layered rounded mat to a mobile device and relay an identity of each flat hexagonal response tag and a current location of the movable character on the interactive surface to the mobile device.

In some embodiments, the storage compartment comprises an outer shell, an inner compartment, and a lid. The lid is connected to the outer shell by a storage joint and the inner compartment configured to hold the movable character and the flat hexagonal response tags.

In some embodiments, the multi-layered rounded mat has a thickness of 1 millimeter (mm) to 10 mm.

In some embodiments, the storage compartment has a depth of at least 10 mm.

In some embodiments, at least one layer of the multi-layered rounded mat is a top layer partially overlaying the middle layer, and where the top layer is configured to leave the interactive surface uncovered when the lower section is not folded over a portion of the upper surface of the upper section.

In some embodiments, at least one flat hexagonal response tag of the set of flat hexagonal response tags has at least one circular cut-out.

In some embodiments, the first layer comprises a silicone.

In some embodiments, the storage compartment comprises at least one selected from the group consisting of wood, plastic, and metal.

In some embodiments, the storage compartment comprises wood.

In some embodiments, the storage compartment further comprises a device holder comprising at least one selected from the group consisting of a metal, a plastic.

In some embodiments, the device holder has a set of adjustable hinges, configured to support the mobile device at a plurality of angles.

In some embodiments, the multi-layered rounded mat has a thickness of 5 mm.

In some embodiments, the storage compartment has a depth of at least 20 mm.

In some embodiments, the upper section further comprises the circuitry configured to provide the multi-layered rounded mat with an internal power source.

In some embodiments, the circuitry further comprises a charger input and an on/off button.

In some embodiments, the storage compartment has a width of at least 50 mm.

In some embodiments, the storage compartment further comprises three pre-divided areas configured to individually hold the movable character, the flat hexagonal response tags, and the device holder.

In some embodiments, the storage compartment has a length of at least 150 mm.

In some embodiments, the multi-layered rounded mat has a circular shape with a diameter of at least 300 mm.

In some embodiments, the interactive surface has a circular shape with a diameter of at least 100 mm.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a schematic perspective view of a therapy assistive system, according to certain embodiments;

FIG. 1B illustrates an exploded view of a movable character included in the therapy assistive system, according to certain embodiments;

FIG. 1C illustrates a set of flat hexagonal response tags included in the therapy assistive system, according to certain embodiments;

FIG. 1D illustrates a folded configuration of the therapy assistive system of FIG. 1A, according to certain embodiments;

FIG. 2A illustrates a top view of the therapy assistive system of FIG. 1A, according to certain embodiments;

FIG. 2B illustrates a side view of the therapy assistive system of FIG. 1A, according to certain embodiments;

FIG. 2C illustrates a rear view of the therapy assistive system of FIG. 1A, according to certain embodiments;

FIG. 2D illustrates a perspective view of the therapy assistive system of FIG. 1A, according to certain embodiments;

FIG. 2E illustrates an exploded view of a storage joint of the therapy assistive system of FIG. 1A, according to certain embodiments

FIG. 2F illustrates a rear view of a portion of the therapy assistive system showing an assembled view of the storage joint, according to certain embodiments;

FIG. 3A illustrates a schematic exploded view of the therapy assistive system depicting a multi-layered architecture, according to certain embodiments;

FIG. 3B illustrates a schematic diagram of the therapy assistive system attached with an exemplary mobile device, according to certain embodiments;

FIG. 3C illustrates a schematic diagram of a device holder for the exemplary mobile device, according to certain embodiments;

FIG. 3D is a schematic diagram of a portion of the therapy assistive system depicting three pre-divided areas included in a storage compartment of the therapy assistive system, according to certain embodiments;

FIG. 4A illustrates an exemplary display screen of the mobile device depicting an introduction page of an application for the therapy assistive system, according to certain embodiments;

FIG. 4B illustrates an exemplary display screen of the mobile device depicting the movable character included in the therapy assistive system, according to certain embodiments;

FIG. 4C illustrates an exemplary display screen of the mobile device depicting another movable character and a selectable option of the application, according to certain embodiments;

FIG. 4D illustrates an exemplary display screen of the mobile device depicting a questionnaire include in the application, according to certain embodiments;

FIG. 4E illustrates an exemplary display screen of the mobile device depicting a plurality of steps included in a recovery program associated with the application, according to certain embodiments;

FIG. 4F illustrates another exemplary display screen of the mobile device depicting a plurality of steps included in a recovery program associated with the application, according to certain embodiments;

FIG. 4G illustrates an exemplary display screen of the mobile device depicting a plurality of character element and a semi-complete character of the application, according to certain embodiments;

FIG. 4H illustrates an exemplary display screen of the mobile device depicting completed character of the application, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed towards a therapy assistive system. The present disclosure aims towards providing enhanced and more efficient solutions for management and treatment of obsessive-compulsive disorder (OCD). The therapy assistive system is configured with interactive elements for an individual with OCD and remote operation functionalities for a treating medical professional to monitor a progress of the individual with OCD. The therapy assistive system as described herein comprises circuitry having a wireless communication sensor that may connect to a mobile device, the circuitry configured to receive periodic updates on latest protocols and treatment regimens pertaining to OCD from the wireless communication sensor and the mobile device. The therapy assistive system has a portable design and compact form factor. As a result, the therapy assistive system may be used from anywhere, even outside a clinical setting to support the individual with OCD.

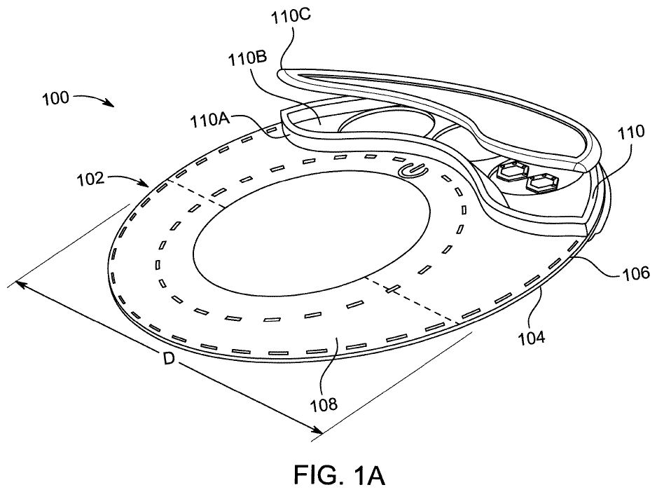

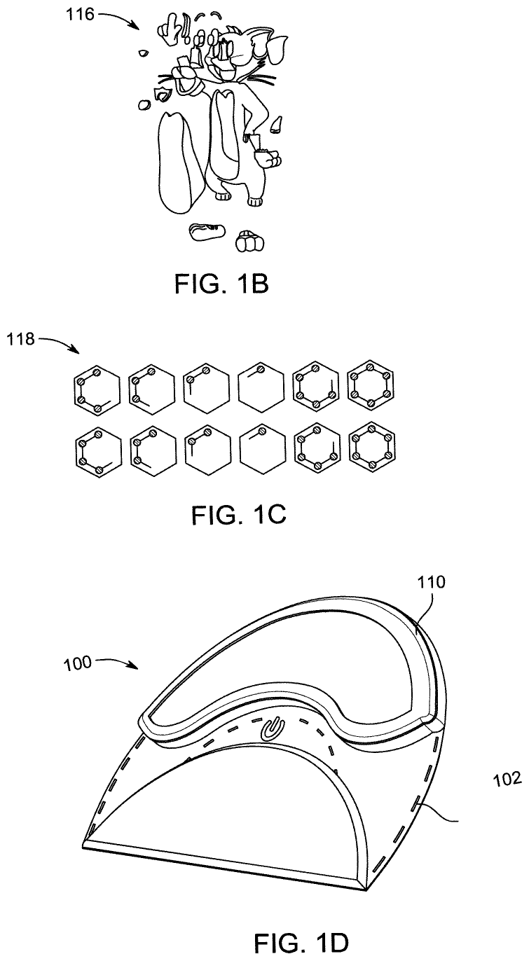

Referring to FIG. 1A, a schematic perspective view of a therapy assistive system 100 is illustrated, according to certain embodiments. The therapy assistive system 100 is configured to assist a user with OCD and the treating medical professional, with a therapeutic solution for OCD. A person with ordinary skill in the art would understand that the therapeutic assistive system 100 may be interchangeably referred to as “the system 100” hereinafter, for brevity in explanation. The system 100 comprises a multi-layered rounded mat 102. In one embodiment, the multi-layered rounded mat 102 has a thickness ‘T’ of 1 millimeter (mm) to 10 mm. The thickness ‘T’ is defined by a top surface and a bottom surface of the multi-layered rounded mat 102. In another embodiment, the multi-layered rounded mat 102 has a T of 2 to 9 mm, preferably 3 to 8 mm, preferably 4 to 7 mm, preferably 5 to 6 mm, most preferably 5 mm. Further, the multi-layered rounded mat 102 has a circular shape which defines a diameter ‘D’ extending from a first end to a distal end of the multi-layered rounded mat 102. In one embodiment, the multi-layered rounded mat 102 comprises a D of at least 300 mm, preferably at least 305 mm, preferably at least 310 mm, preferably at least 315 mm, preferably at least 320 mm, preferably at least 325 mm, preferably at least 330 mm, preferably at least 335 mm, preferably at least 340 mm, most preferably at least 345 mm. The diameter of the multi-layered rounded mat 102 is case dependent and may vary from user to user to best suit requirements of a particular user

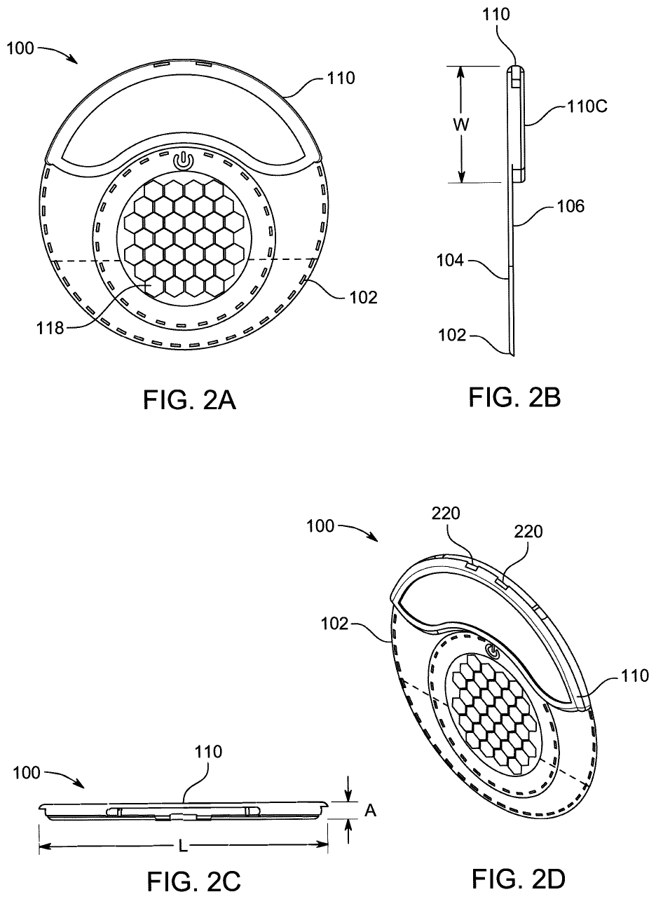

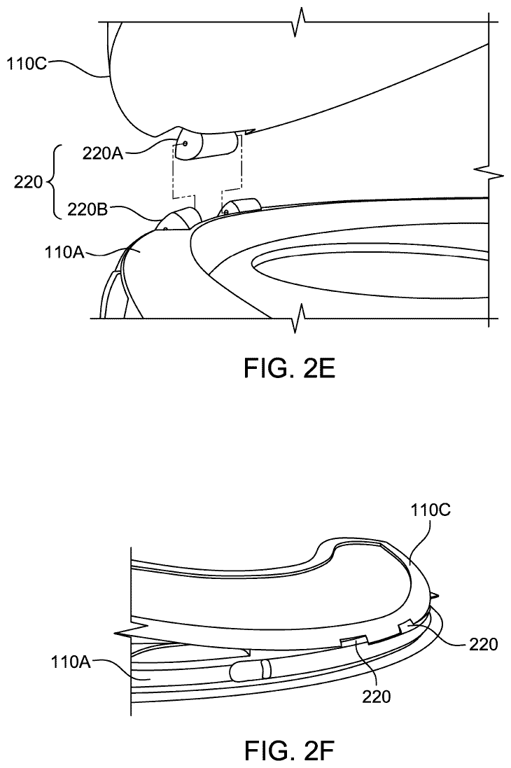

The multi-layered rounded mat 102 further comprises a lower section 104 and an upper section 106. The lower section 104 constitutes bottom components of the system 100 whereas the upper section 106 comprises a plurality of aesthetic design elements as well as functional components associated with the system 100. The upper section 106 comprises an upper surface 108 which is a top surface of the system 100. The upper section 106 comprises a storage compartment 110 disposed on the upper surface 108 opposite the lower section 104. A size of the storage compartment 110 may be defined depending upon the requirements of the user. The storage compartment 110 comprises an outer shell 110A, an inner compartment 110B, and a lid 110C. As such, the lid 110C is connected to the outer shell 110A by a storage joint 220 (shown in FIG. 2D). In one embodiment, the storage compartment 110 has a depth ‘A’ of at least 20 mm, defined between a top end and a bottom end of the outer shell 110A. In another embodiment, the storage compartment has a depth of at least 10 mm, preferably at least 12 mm, preferably at least 14 mm, preferably at least 16 mm, preferably at least 18 mm, most preferably at least 20 mm. Further, the storage compartment 110 has a length ‘L’ of at least 100 mm, preferably at least 110 mm, preferably at least 120 mm, preferably at least 130 mm, most preferably at least 140 mm extending from a first end of the storage compartment 110 to a distal end of the storage compartment 110. Furthermore, the storage compartment comprises a width ‘W’ of at least 40 mm, preferably at least 45 mm, preferably at least 50 mm, preferably at least 55 mm, preferably at least 60 mm, preferably at least 65 mm, most preferably at least 70 mm, extending from a top end to a bottom end of the storage compartment 110. The inner compartment 110B is configured to store key components associated with the system 100. Moreover, the storage compartment 110 comprises at least one selected from the group consisting of wood, plastic, and metal. According to the present disclosure, the storage compartment 110 comprises wood. In certain implementations of the present disclosure, plastic and metal (including alloys) may also be used to construct the storage compartment 110.

Referring to FIG. 1B and FIG. 1C, schematic representations of the key components of the therapy assistive system 100 are illustrated, according to certain embodiments. In particular, FIG. 1B depicts an exploded view of a movable character 116 and FIG. 1C depicts a set of flat hexagonal response tags 118. The therapy assistive system 100 comprises the movable character 116 and the set of flat hexagonal response tags 118, where each of the set of flat hexagonal response tags 118 comprises a unique pattern of cut-outs penetrating through a body of the flat hexagonal response tag 118. As such, at least one flat hexagonal response tag of the set of flat hexagonal response tags 118 has at least one circular cut-out. In order to make the therapy assistive system 100 portable, the movable character 116 and the flat hexagonal response tags 118 are able to be stored in the storage compartment 110. More specifically, the inner compartment 110B is configured to store the movable character 116 and the flat hexagonal response tags 118. Further, the movable character 116 is configured to be an interactive tool in the system 100. In some embodiments, the movable character 116 is configured to be disassembled into a plurality of parts and then reassembled by the user of the system 100. The reassembly process allows for a more interactive engagement of the user with the movable character 116 and subsequently, the system 100. In addition, the movable character 116 may be designed with BPA-free wood having a smooth finish, which provides desirable safety parameters to a user of younger age. The BPA-free wood ensures that the movable character 116 can be disassembled and reassembled multiple times without wear and tear, providing longevity to the system 100. The movable characters 116 may be tracked by the system 100 in order to track progress of the user undergoing therapy for OCD. In one embodiment, the progress tracking contributes towards enhanced therapy, as well as more controlled management of OCD systems in the user.

Referring to FIG. 1D, a schematic perspective view of the system 100 is illustrated, according to certain embodiments. In particular, FIG. 1D depicts a folded configuration of the system 100. As shown in FIG. 1D, the lower section 104 is configured to be foldable over a portion of the upper surface 108 of the upper section 106 at a straight constriction of the thickness of the multi-layered rounded mat 102, as shown by a dotted line in FIG. 1A. In some embodiments, the multi-layered rounded mat 102 may have a polygon shape or any other shape known in the art. Further, a distance of the straight constriction may be adjusted depending on a requirement of the user of the system 100. In an example, the size of the multi-layered rounded mat 102 may be custom made for a particular user, keeping in mind an age of the user, to provide the user maximum portability for the system 100.

Referring to FIG. 2A, FIG. 2B, FIG. 2C, and FIG. 2D, schematic multi-directional views of the therapy assistive system 100 are illustrated, according to certain embodiments. In particular, FIG. 2A depicts a top view of the system 100, FIG. 2B depicts a side view of the system 100, FIG. 2C depicts a rear view of the system 100, and FIG. 2D depicts a perspective view of the system 100. As can be seen from FIG. 2A, the therapy assistive system 100 comprises the set of flat hexagonal response tags 118, which are arranged in closed proximal pattern. The flat hexagonal response tags 118 and associated proximal pattern thereof is assessed by the system 100 and then by the psychologist providing care to the user with OCD. The proximal pattern may be unique to each arrangement, as carried out by the user to tackle certain compulsive behavior traits. Further, as can be seen from FIG. 2B, the thickness of the multi-layered rounded mat 102 is less than a thickness of the storage compartment 110. As can be seen from FIG. 2C, the rear view of the system 100 shows the length (L) and the depth (A) of the storage compartment 110. Furthermore, FIG. 2D shows the storage joint 220, configured to mechanically couple the lid 110C with the outer shell 110A of the storage compartment 110. The storage joint 220 is designed to be modular in nature. In order for better understanding, FIG. 2E illustrates an exploded view of the storage joint 220, according to certain embodiments. As shown in FIG. 2E, the storage joint 220 comprises a top portion 220A and a bottom portion 220B. The bottom portion 220B is configured to receive and secure the top portion 220A. In some embodiments, a metal pin may be used to movably couple the bottom portion 220B with the top portion 220A of the storage joint 220. In some embodiments, the top portion 220A may be configured with a set of protrusions configured to be protruding from each side of the top portion 220A and the bottom portion 220B may be configured to receive the set of protrusions to form a secured storage joint 220. Referring to FIG. 2F, an assembled view of the storage joint 220 is illustrated, according to certain embodiments. The storage joint 220 is configured to include a plurality of angle adjustments, as such, the storage joint 220 may be adjusted at a certain angle as desired by the user. Further, the storage joint 220 is configured to provide a weatherproof seal to the storage compartment 110, in order to protect the movable character 116 and the flat hexagonal response tags 118 from undesired weather elements such dust, dirt, and moisture. The storage joint 220 further provide the system 100 with a portable architecture, with suitable dimensions for young users and a considerably compact body for ease of transport, storage, and use.

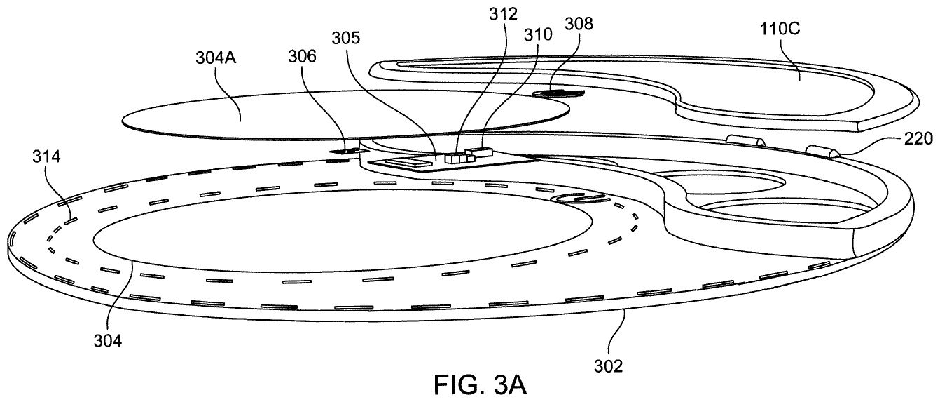

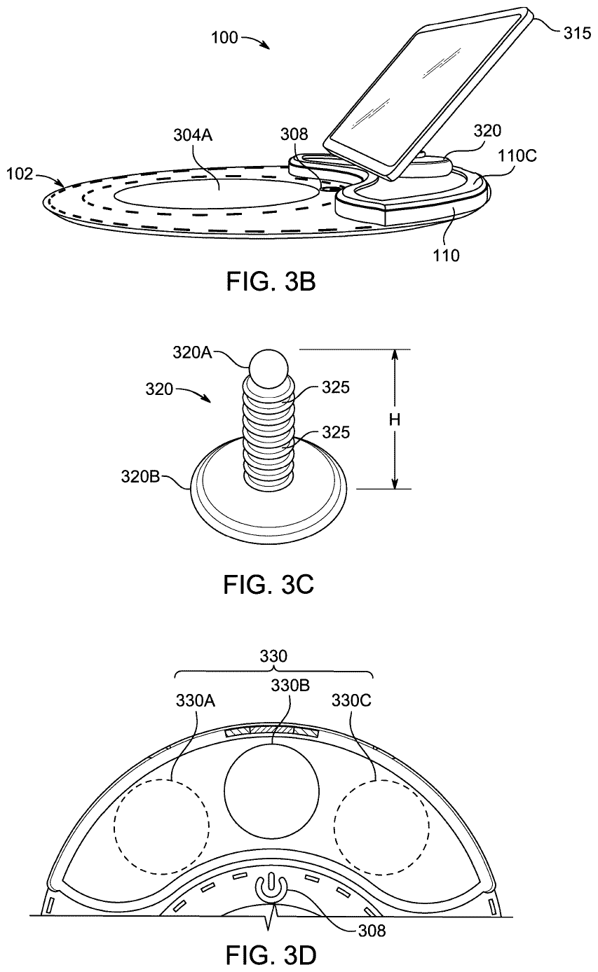

Referring to FIG. 3A, a schematic exploded view of the therapy assistive system 100 is illustrated, according to certain embodiments FIG. 3A depicts a layered architecture of the system 100, further defining a plurality of layers included in the multi-layered rounded mat 102. A person with ordinary skill in the art would understand the multi-layered rounded mat 102 may include more layers than depicted herein with respect to FIG. 3A. In some embodiments, the multi-layered rounded mat 102 comprises a first layer 302 which is a bottommost layer of the therapy assistive system 100. In other words, a base layer of the multi-layered rounded mat 102 is referred to as the first layer 302. As such, the first layer 302 comprises at least one selected from the group consisting of a silicone, a polyurethane, a rubber, and a plastic. According to the present disclosure, the first layer 302 comprises silicone. Silicone is used to manufacture the first layer 302 in order to provide desired grip to the multi-layered rounded mat 102, required for anti-slip functioning of the system 100 on a surface. In general, silicone is readily available at manufacturing facilities and may assist manufacturers in keeping the costs down, associated with the system 100. Further, a second layer 304 of the multi-layered rounded mat 102 comprises a second layer 304 which is a middle layer. In other words, a central layer of the multi-layered rounded mat 102 is referred to as the second layer 304. The second layer 304 comprises an interactive surface 304A. In one embodiment, the interactive surface 304A is a touch sensitive platform, configured to sense a motion initiated by the user of the system 100. In another embodiment, the interactive surface 304A comprises a display panel with touch sensitivity, in order to display required information to the user. The interactive surface 304A is configured to detect a location of the movable character 116 and the flat hexagonal response tags 118, present on the interactive surface 304A during the course of a therapy session being carried out on the therapy assistive system 100 by a registered mental health professional. In one embodiment, the interactive surface 304A has a circular shape with a diameter of at least 100 mm, preferably at least 110 mm, preferably at least 120 mm, preferably at least 130 mm, preferably at least 140 mm, preferably at least 150 mm, most preferably at least 160 mm. In another embodiment, the interactive surface 304A may have any other shape known in the art, with varying dimensions based on a requirement of the user.

The therapy assistive system 100 comprises a plurality of electrical and electronic components for desired operation. As such, the second layer 304 comprises a circuitry 305. The upper section 106 of the system 100 further comprises the circuitry 305 configured to provide the multi-layered rounded mat 102 with an internal power source (not shown). Specifically, a part of the circuitry 305 is included in the upper section 106 which is responsible for supplying electrical power to the system 100. The internal power source may include a lithium-ion battery, or any other remote power sources known in the art. In order for the system 100 to be a portable system, the internal power source may be rechargeable. Therefore, the circuitry 305 further comprises a charger input 306 and an on/off button 308 (power button). The charger input 306 is electrically coupled with the circuitry 305, and the charger input 306 is configured to receive an alternating current, or a direct current from an outside electrical power source. The charger input 306 further converts the received current into charge and stores the charge in the internal power source. Moreover, in some embodiments, the power button 308 is configured to switch ON and OFF the therapy assistive system 100. Dual function design allows for a compact and sophisticated system 100, saving internal space for other electrical components. In some embodiments, the power button 308 may include an in-built biometric scanner, configured to scan and register a fingerprint of the user and treating medical professional to maintain safety and privacy of the user.

Furthermore, the circuitry 305 comprises a wireless communication sensor 310 and a light sensor 312. In some embodiments, the light sensor 312 is in communication with the wireless communication sensor 310 and is configured to identify the unique pattern of cut-outs present on the flat horizontal response tags 118. The unique pattern of cut-outs provides a unique identity to each response tag 118 present in the system 100. The light sensor 312 is further configured to relay an identity of the flat horizontal response tags 118 based on the unique pattern of cut-outs to the wireless communication sensor 310. In an example, when the user places the set of response tags 118 on the interactive surface 304A, a pattern is generated by the unique patter of cut-outs present on the flat horizontal response tags, which is then sensed by the light sensor 312 to identify the identity of the response tag the user has selected. The generated pattern is then read by the wireless communication sensor 310 and is further relayed to the system 100. In some embodiments, to enable remote functioning of the system 100, the wireless communication sensor 310 is employed in the system 100. The wireless communication sensor 310 may include a Bluetooth sensor or a Wi-Fi sensor to enable the system to connect to a local internet network and/or a mobile device. In some embodiments, the wireless communication sensor 310 may also include a near field communications (NFC) module to further enable the system to connect to and exchange digital content with other electronic devices.

Further, in some embodiments, the system 100 comprises a top layer 314. In one embodiment of the system 100, at least one layer of the multi-layered rounded mat 102 is the top layer 314, partially overlaying the middle (second) layer 304. In addition, the top layer 314 is configured to leave the interactive surface 304A uncovered when the lower section 104 of the multi-layered rounded mat 102 is not folded over a portion of the upper surface 108 of the upper section 106. In other words, the top layer 314 is configured to confine the surroundings of the interactive surface 304A, in a circular manner to provide protection from scratches and dents to the interactive surface 304A, and structural integrity to the multi-layered rounded mat 102. In some embodiments, the first layer 302, the second layer 304, and the top layer 314 are pressed together, so that the first layer 302 forms a base of the multi-layered rounded mat 102, followed by the central layer formed by the second layer 304, and further the top layer 314. The first, second, and top layers 302, 304, 314 are configured to be stitched together at a seam of the multi-layered rounded mat 102 to provide longevity to the system 100. In some embodiments, the first, second, and top layers 302, 304, 314 may be pasted together and then stitched.

Referring to FIG. 3B, a schematic perspective of the therapy assistive system 100 with an exemplary mobile device 315 is illustrated, according to certain embodiments. In particular, FIG. 3B comprises the mobile device 315, however, a person with ordinary skill in the art would understand that any other kind of smart mobile device may be used in place of the mobile device 315 depicted herein. In some embodiments, the wireless communication sensor 310 is configured to wirelessly connect the second layer 304 of the multi-layered rounded mat 102 to the mobile device 315. In some embodiments, the mobile device 315 may include, but not limited to, an android smartphone, an iOS smartphone, and a tablet computing device. In an embodiment, the wireless communication sensor 310 in conjunction with the multi-layered rounded mat 102 is configured to relay the identity of each flat horizontal response tag 118 and a current location of the movable character 116 on the interactive surface 304A to the mobile device 315. The mobile device 315 displays a data related to the aforementioned information, which may assist a psychologist or a user in tracking recovery progress for a treatment protocol chosen to treat and manage OCD. The mobile device 315 is stored in a device holder 320 configured in the storage compartment 110. Referring to FIG. 3C, a schematic diagram of the device holder 320 is illustrated, according to certain embodiments. As shown in FIG. 3C, the device holder 320 has an elongated structure with a height ‘H’, further the device holder comprises a base 320A and an attachment protrusion 320B. The base 320A is configured to be in physical contact with the lid 110C of the storage compartment 110 and the attachment protrusion 320B is configured to connect with a receiver that may be installed on the mobile device 315. In some embodiments, the device holder 320 comprises at least one selected from the group consisting of a metal, a plastic. According to the present disclosure, the device holder 320 may be manufactured using an acrylonitrile butadiene styrene (ABS) plastic. In some embodiments, the device holder 320 comprises a set of adjustable hinges 325, configured to support the mobile device 315 at a plurality of angles. As can be seen from FIG. 3B, the adjustable hinges 325 allows for a customizable positioning and a custom angle of placement for the mobile device 315 for the user. The positioning may be adjusted based on a viewing angle of the user.

Referring to FIG. 3D, a schematic diagram depicting three pre-divided areas 330 for storing key components associated with the system 100 is illustrated, according to certain embodiments. More specifically, the storage compartment 110 further comprises three pre-divided areas 330. In some embodiments, the three pre-divided areas include a first area 330A, a second area 330B, and a third area 330C. The three pre-divided areas 330 are configured to individually hold the movable character 116, the flat hexagonal response tags 118, and the device holder 320. More specifically, the first area 330A is configured to hold the set of response tags 118, the second area 330B is configured to mount the device holder 320, and the third area 330C is configured to hold the movable character 116. Further, the storage compartment 110 may include more than three pre-divided areas in accordance with specific requirements of the user. The three pre-divided areas 330 provide a dedicated place for the key components associated with the system 100 providing enhanced portability to the system 100.

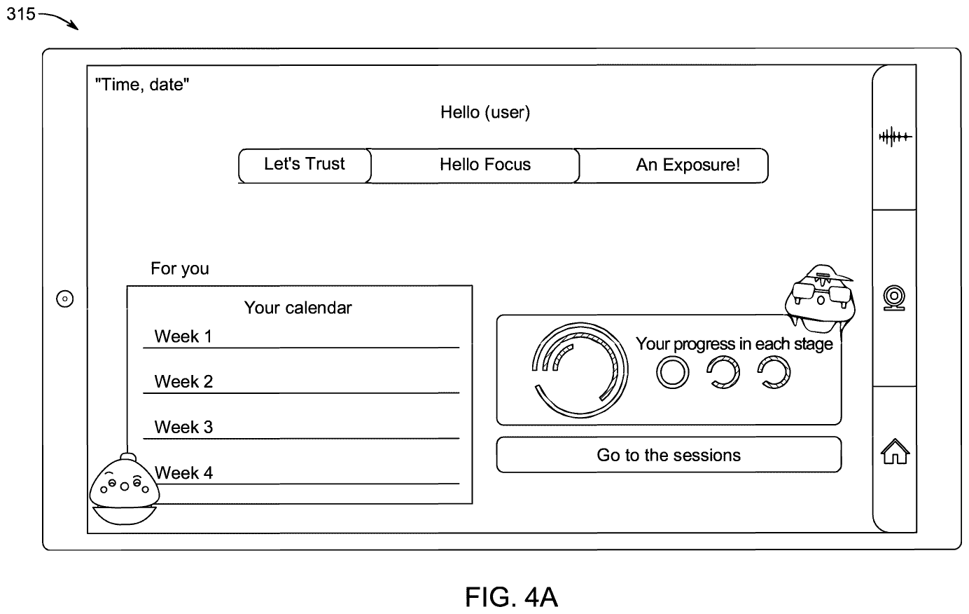

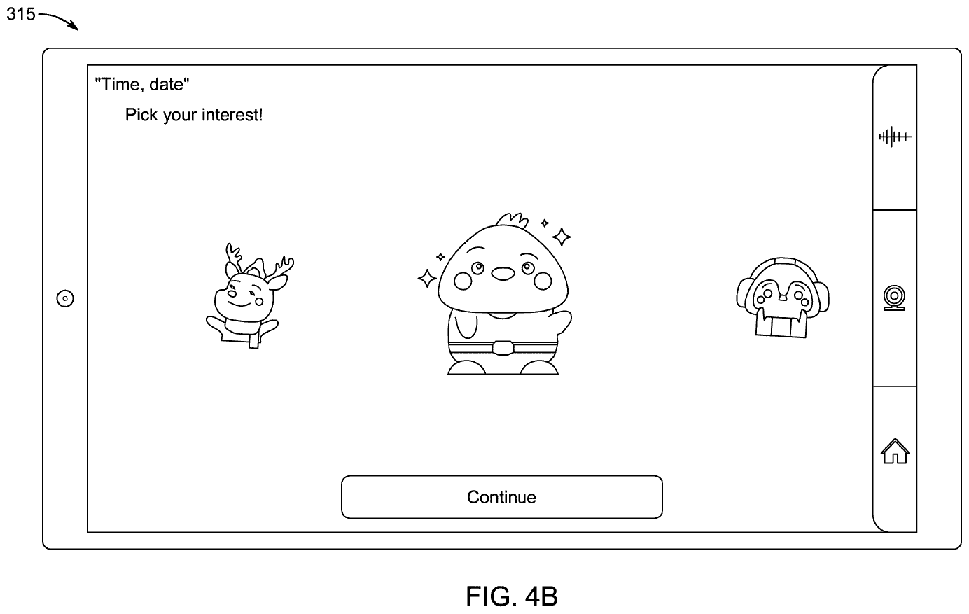

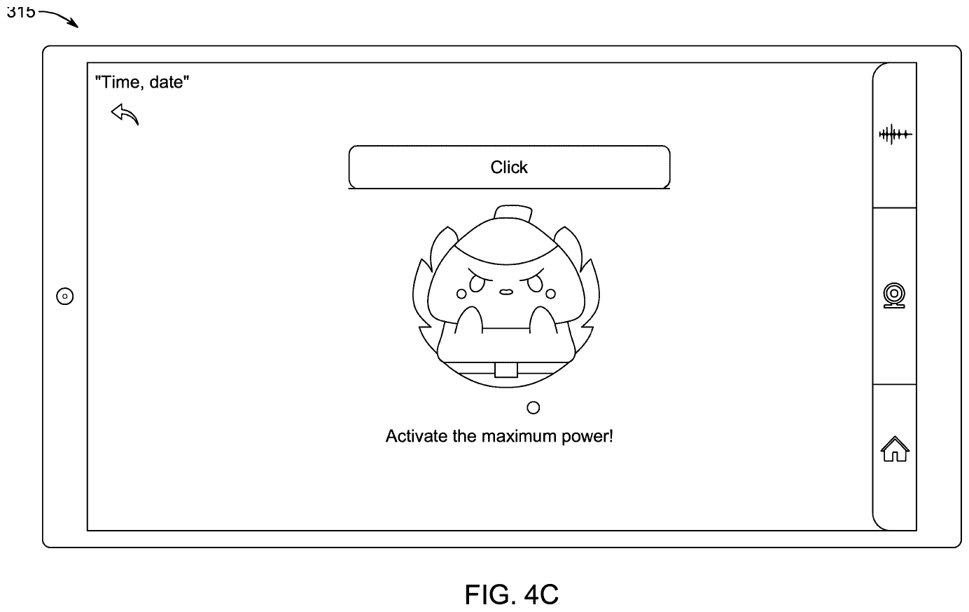

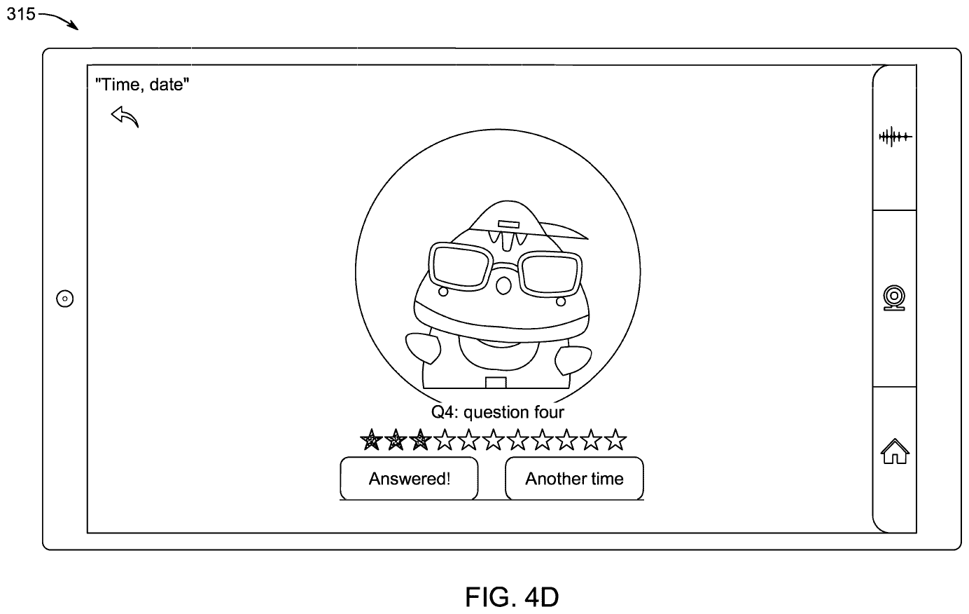

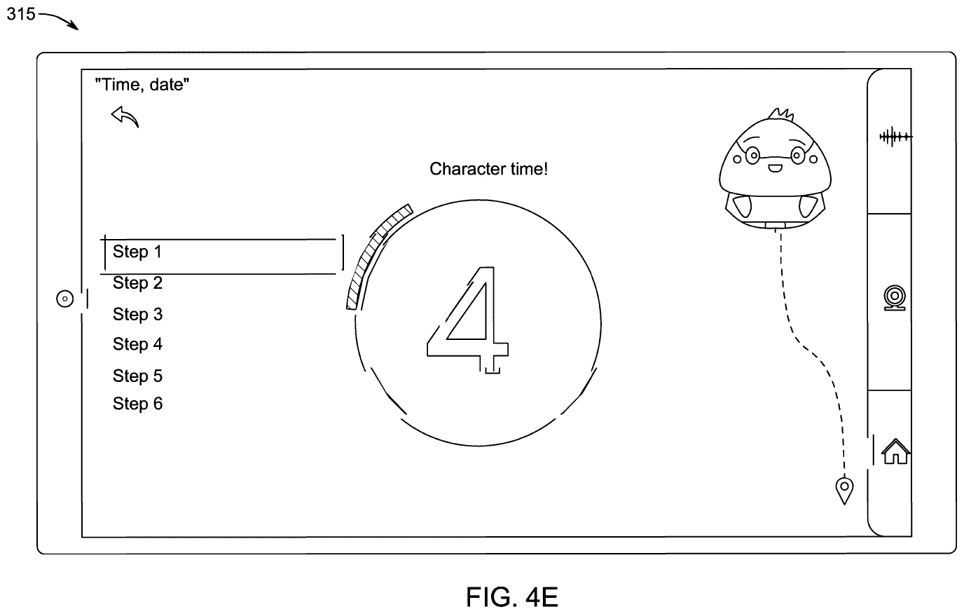

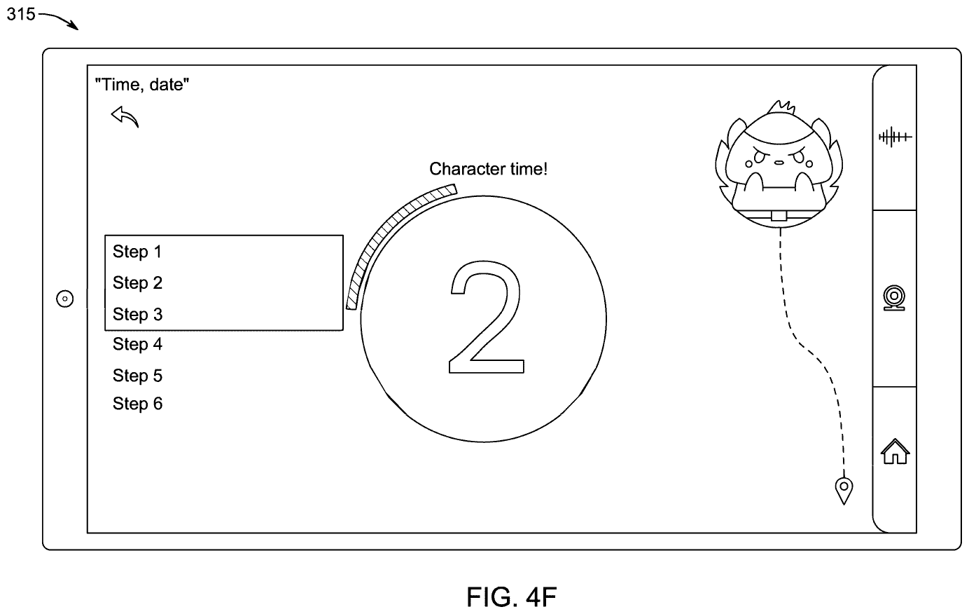

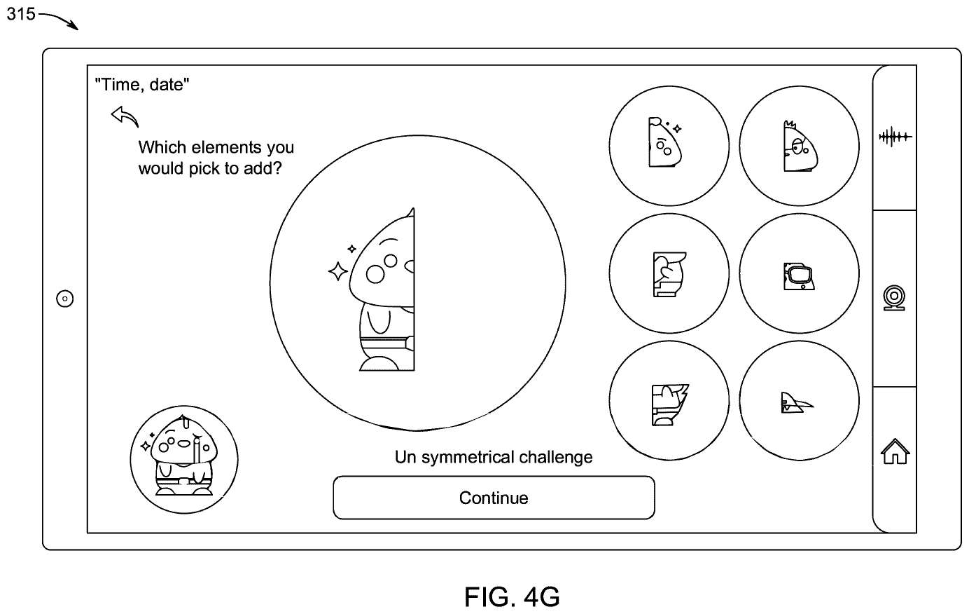

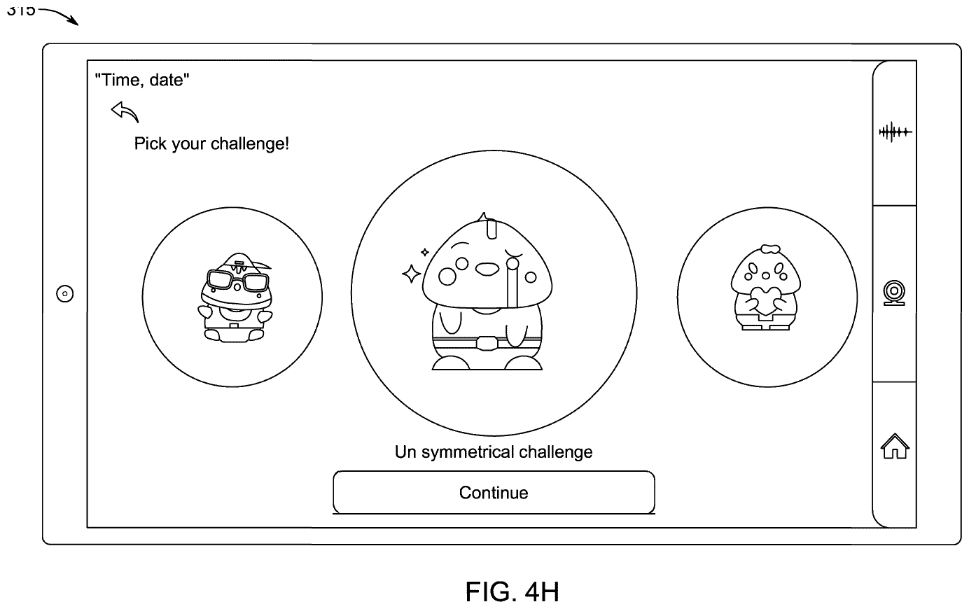

In some embodiments, the wireless communication sensor 310 is configured to connect to a mobile device having a computing software, alternatively referred to as an application, to assist the user with OCD therapy will using the system. Referring to FIGS. 4A-4H, a set of exemplary screen images of the application are illustrated, according to certain embodiments. The screen images included herein are only exemplary and the application may further include a plurality of functionalities and features. As can be seen from FIG. 4A, the application displays introduction screen which comprises information pertaining to the user and their progress in a week-wise manner. As can be seen from FIG. 4B, the application displays a pictorial representation of the movable character 116, which is used in the system 100 to assist the user with therapy. Further, FIG. 4C displays another image of the movable character 116 and a selectable option is prompted on the screen of the mobile device for the user to select and proceed with the dedicated movable character 116. In some implementations, the application may include a plurality of character images in order to provide the user with a wide array of options to select therefrom. As can be seen from FIG. 4D, the application displays a questionnaire for the user and further evaluates the user on basis of a response and answers submitted by the user. Furthermore, FIG. 4E and FIG. 4F displays the movable character 116 and a plurality of steps associated with the therapy program opted by the user. In some embodiments, a number of steps included in the therapy program is dependent on a severity of OCD of the user. As can be seen from FIG. 4G, the application displays a plurality of character elements and a semi-complete character. In general, people suffering from OCD face difficulties when they face asymmetrical, disorganized, chaotic, cluttered, shambolic, and scruffy scenarios. OCD patients may have obsessions, compulsions, or both to get rid of the aforementioned scenarios. In order to mitigate this issue, exposure therapy is utilized. On similar principles, the application offers the user to choose from the plurality of character elements, which are designed to be asymmetric on purpose. As can be seen from FIG. 4H, the user may select an asymmetrical character element from the plurality of character elements to complete the semi-complete character and then the user may be therapized using exposure therapy with respect to the asymmetric character. In certain embodiments, the application may include more exposure therapy protocols, such as, but not limited to, in-vivo exposure, imaginal exposure, and flooding exposure. In addition, the application included in the mobile device 315 may further include tools for the treating medical professional in order to track the progress of the user and intervene when required to support the user with any assistance required during the therapy.

The aspects of the present disclosure provide the therapy assistive system 100. Specifically, the therapy assistive system 100 is configured to support in therapy of individuals suffering from OCD. However, in certain embodiments, the system 100 may also be useful in other mental health conditions and challenges increasingly faced by individuals. The interactive elements included in the system 100 are key to enhanced and more efficient recovery of the individuals with OCD, since the individual may feel more dialed-in due to the interactive nature of the system 100. Further, the portability of the system 100 is yet another advantage that may circumvent the drawbacks of traditional therapeutic approaches. The portability of the system 100 may allow the individual with OCD to take therapy sessions from home, or remotely. This allows for a more fluid and dynamic therapy protocol, specifically designed to cater the individual's requirements. The remote therapy sessions may accelerate therapy progress and may also be of assistance during emergency flare-up episodes of OCD. Furthermore, the application, in conjunction with the mobile device 315 and the system 100, allows for over-the-air (OTA) update of therapy protocols and sessions as new research come to light. The ability to connect to a mobile device 315 and interactive therapy sessions are a significant advantage of the system 100 and may impact the individual with OCD in a positive manner. The mobile device 315 also allows the individual using the system 100 with remote tests and evaluations, so that the treating medical professional can intervene in accordance with the requirements of the user. Further, the multi-layered architecture of the system 100 provides a durable structure for longer utilization intervals, providing excellent resistance to wear and tear. In addition, the movable character 116 and the flat hexagonal response tags 118 are modular in nature, as such, when the individual with OCD has completed a certain therapeutic exercise in a therapy session, the movable character 116 and the flat hexagonal response tags 118 may be switched in order to provide continuous positively challenging situations to the individual, further aiding to faster recovery and more effective therapy. Lastly, the modular nature of the system 100 in conjunction with the portability of the system 100 provide a synergistic approach to OCD recovery therapies, and this may allow current individuals and treating medical professionals to include the system 100, as described herein, to their particular therapeutic regimen.

Numerous modifications and variations of the present disclosure are possible in light of the above teachings. It is therefore to be understood that the invention may be practiced otherwise than as specifically described herein.

1. A therapy assistive system, comprising:
a multi-layered rounded mat comprising a lower section and an upper section, the lower section being foldable over a portion of an upper surface of the upper section at a straight constriction of the thickness of the mat, the upper section having a storage compartment disposed on the upper surface opposite lower section;
a movable character; and
a set of flat hexagonal response tags, each having a unique pattern of cut-outs penetrating through a body of the flat hexagonal response tag,
wherein a first layer of the multi-layered rounded mat is a bottommost layer comprising at least one selected from the group consisting of a silicone, a polyurethane, a rubber, and a plastic,
wherein a second layer of the multi-layered rounded mat is a middle layer comprising an interactive surface, the interactive surface being configured to detect a location of the movable character and response tags present on the interactive surface, and
wherein the second layer further comprises circuitry having a wireless communication sensor and a light sensor, the light sensor being in communication with the wireless communication sensor and configured to identify the unique pattern of cut-outs present on the flat hexagonal response tags and relay an identity of the flat hexagonal response tags based on the unique pattern of cut-outs to the wireless communication sensor, wherein the wireless communication sensor is configured to wirelessly connect the second layer of the multi-layered rounded mat to a mobile device and relay an identity of each response tag and a current location of the movable character on the interactive surface to the mobile device.

2. The system of claim 1, wherein the storage compartment comprises an outer shell, an inner compartment, and a lid, the lid connected to the outer shell by a storage joint and the inner compartment configured to hold the movable character and the flat hexagonal response tags.

3. The system of claim 1, wherein the multi-layered rounded mat has a thickness of 1 to 10 mm.

4. The system of claim 1, wherein the storage compartment has a depth of at least 10 mm.

5. The system of claim 1, wherein at least one layer of the multi-layered rounded mat is a top layer partially overlaying the middle layer, and
wherein the top layer is configured to leave the interactive surface uncovered when the lower section is not folded over a portion of the upper surface of the upper section.

6. The system of claim 1, wherein at least one flat hexagonal response tag of the set of flat hexagonal response tags have at least one circular cut-out.

7. The system of claim 1, wherein the first layer comprises silicone.

8. The system of claim 1, wherein the storage compartment comprises at least one selected from the group consisting of wood, plastic, and metal.

9. The system of claim 1, wherein the storage compartment comprises wood.

10. The system of claim 1, wherein the storage compartment further comprises a device holder comprising at least one selected from the group consisting of a metal, a plastic.

11. The system of claim 10, wherein the device holder has a set of adjustable hinges, configured to support the mobile device at a plurality of angles.

12. The system of claim 1, wherein the multi-layered rounded mat has a thickness of 5 mm.

13. The system of claim 1, wherein the storage compartment has a depth of at least 20 mm.

14. The system of claim 1, wherein the upper section further comprises circuitry configured to provide the multi-layered rounded mat with an internal power source.

15. The system of claim 14, wherein the circuitry further comprises a charger input and an on/off button.

16. The system of claim 1, wherein the storage compartment has a width of at least 40 mm.

17. The system of claim 1, wherein the storage compartment further comprises three pre-divided areas that are configured to individually hold the movable character, the flat hexagonal response tags, and the device holder.

18. The system of claim 1, wherein the storage compartment has a length of at least 150 mm.

19. The system of claim 1, wherein the multi-layered rounded mat has a circular shape with a diameter of at least 300 mm.

20. The system of claim 1, wherein the interactive surface has a circular shape with a diameter of at least 100 mm.
